(19) United States
(12) Patent Application Publication
(10) Pub. No.: US 2019/0001830 A1
(43) Pub. Date: Jan. 3, 2019

(54) METHOD AND SYSTEM FOR AUTO-CHARGING

(71) Applicant: Faraday&Future Inc., Gardena, CA (US)

(72) Inventors: Chi Hung Cao, Huntington Beach, CA (US); Richard S. Kim, Los Angeles, CA (US); Mike de Jung, Marina del Rey, CA (US); Jason Huang, Fremont, CA (US)

(21) Appl. No.: 15/691,676

(22) Filed: Aug. 30, 2017

Related U.S. Application Data
(60) Provisional application No. 62/382,014, filed on Aug. 31, 2016.

(51) Int. Cl. B60L 11/18; G01B 7/31; G01B 13/19; G01B 11/27

(52) U.S. Cl. CPC B60L 11/1835; B60L 11/1816; B60L 2230/10; G01B 13/19; G01B 11/272; G01B 7/31

(57) ABSTRACT

An auto-charging system is disclosed. The system may comprise a base and a set of lower arms. The set of lower arms may comprise a first lower arm and a second lower arm each having a first end and a second end. The first end of the first lower arm may be attached to the base, and the second ends of the first and second lower arms may be attached to a hinge joint. The system may further comprise an upper arm having a first end attached to the hinge joint and a second end, a charger arm having a first end attached to second end of the upper arm and a second end, the set of lower arms, the upper arm, and the charger arm being foldable into the base, and a charger attached to the second end of the charger arm.

### CROSS-REFERENCE TO RELATED APPLICATIONS

This application claims the benefit of U.S. Provisional Application No. 62/382,014, filed Aug. 31, 2016, the entirety of which is hereby incorporated by reference.

### TECHNICAL FIELD

The present disclosure relates generally to methods and systems for auto-charging, and more particularly, to methods and systems for auto-charging vehicles.

### BACKGROUND

Electric vehicles have become popular consumer products to replace existing energy-inefficient vehicles. For electric vehicle drivers, instead of refilling gas tanks, they need to recharge these battery-powered vehicles from time to time. However, in some cases, the drivers may forget to recharge the vehicle, may be too busy to take care of recharging, or just may find the recharging task troublesome. To properly and timely recharge the electric vehicles for the next use, automatic charging robots need to be developed.

### SUMMARY

One aspect of the present disclosure is directed to an auto-charging system. The system may comprise a base and a set of lower arms. The set of lower arms may comprise a first lower arm and a second lower arm each having a first end and a second end. The first end of the first lower arm may be attached to the base, and the second ends of the first and second arms may be connected to a hinge joint. The system may further comprise an upper arm having a first end attached to the hinge joint and a second end, a charger arm having a first end attached to the second end of the upper arm and a second end, the set of lower arms, the upper arm, and the charger arm being foldable into the base, and a charger attached to the second end of the charger arm. The base may be configured to approach a charging target. The set of lower arms, the upper arm, and the charger arm may be configured to unfold from the base. The charger arm may be configured to deliver the charger to a charger port of the charging target.

Another aspect of the present disclosure is directed to an auto-charging method. The method may comprise moving an auto-charging apparatus to a charging target. The auto-charging apparatus may comprises a set of lower arms, comprising a first lower arm and a second lower arm each having a first end and a second end. The first end of the first lower arm may be attached to the base, the second ends of the first and second arms may be attached to a hinge joint, an upper arm having a first end attached to the hinge joint and a second end, a charger arm having a first end attached to the second end of the upper arm and a second end, and a charger attached to the second end of the charger arm. The method may further comprise unfolding the set of lower arms, the upper arm, and the charger arm from the base, and delivering the charger to a charger port of the charging target.

Another aspect of the present disclosure is directed to an automatic vehicle-charging system. The system may comprise a base and a set of lower arms. The set of lower arms may comprise a first lower arm and a second lower arm each having a first end and a second end. The first end of the first lower arm may be attached to the base, and the second ends of the first and second arms may be attached to a hinge joint. The system may further comprise an upper arm having a first end attached to the hinge joint and a second end, a charger arm having a first end attached to the second end of the upper arm and a second end, the set of lower arms, the upper arm, and the charger arm being foldable into the base, and a charger attached to the second end of the charger arm. The base may be configured to approach a vehicle. The set of lower arms, the upper arm, and the charger arm may be configured to unfold from the base. When the set of lower arms are unfolded, the first lower arm, the second lower arm, and the base are configured to form a triangle to support the upper arm. The charger arm may be configured to deliver the charger to a charger port of the vehicle.

It is to be understood that the foregoing general description and the following detailed description are exemplary and explanatory only, and are not restrictive of the invention, as claimed.

### BRIEF DESCRIPTION OF THE DRAWINGS

The accompanying drawings, which constitute a part of this disclosure, illustrate several embodiments and, together with the description, serve to explain the disclosed principles.

FIG. 1 is a block diagram illustrating an auto-charging system, consistent with exemplary embodiments of the present disclosure.

FIG. 2 is a flowchart illustrating an auto-charging method, consistent with exemplary embodiments of the present disclosure.

FIGS. 3A-3G are graphical representations illustrating operations of an auto-charging system, consistent with exemplary embodiments of the present disclosure.

FIG. 4A is a graphical representation illustrating an auto-charging assembly with an ultrasonic sensor, consistent with exemplary embodiments of the present disclosure.

FIG. 4B is a graphical representation illustrating an auto-charging assembly with prong sensors, consistent with exemplary embodiments of the present disclosure.

FIG. 4C is a graphical representation illustrating auto-charging assembly with an Hall effect sensor, consistent with exemplary embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments consistent with the present invention do not represent all implementations consistent with the invention. Instead, they are merely examples of systems and methods consistent with aspects related to the invention.

Current technologies have not developed specialized robot for automatically charging electric vehicles. The disclosed systems and methods may mitigate or overcome one or more of the problems set forth above and/or other problems in the prior art. Further, deploying such robots in parking garages or other places can eliminate the hassle of setting up vehicle charging, saving labor cost for the garage owners, and providing automatic, convenient, and efficient recharging services for drivers.

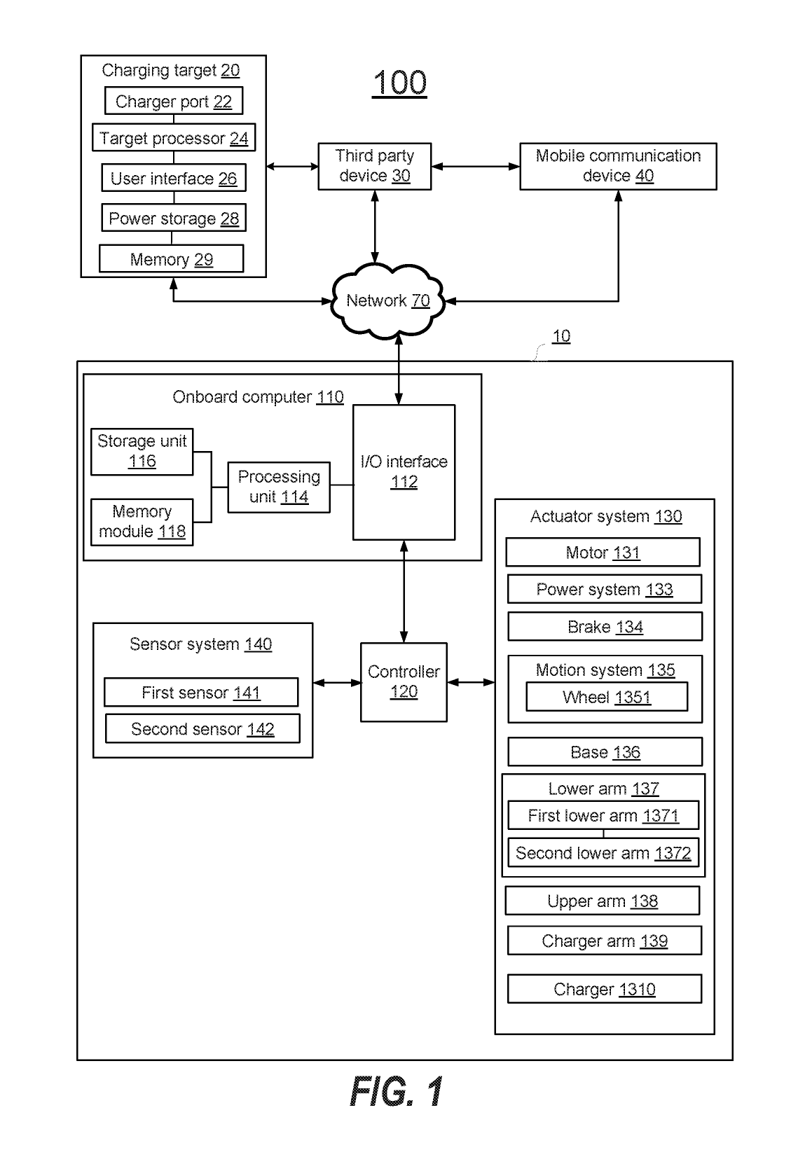

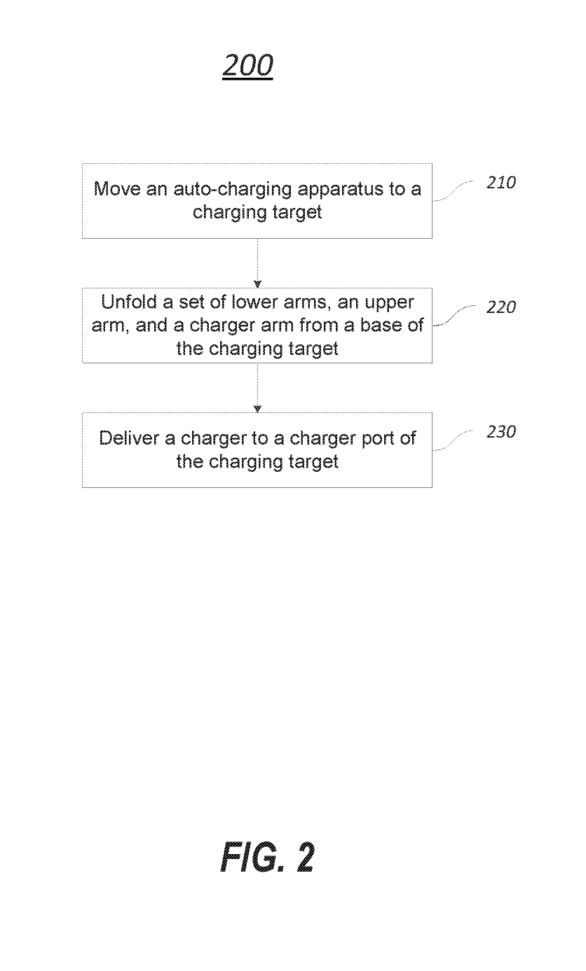

FIG. 1 is a block diagram illustrating an auto-charging system 100, consistent with exemplary embodiments of the present disclosure. System 100 may comprise a number of components and sub-components, some of which may be optional. One or more components of system 100 may be configured to perform method 200 described below with reference to FIG. 2. However, it is not necessary that all of these components be shown in order to disclose an illustrative embodiment.

As illustrated in FIG. 1, system 100 may include an auto-charging assembly 10 and external devices connected via network 70. The external devices may include a charging target 20, a third party device 30, and a mobile communication device 40. Network 70 may be optional. For example, charging target 20 and auto-charging assembly 10 may not be connected by any network.

Charging target 20 may be any system that can be charged or recharged, e.g., a device comprising a rechargeable battery. In some exemplary embodiments, charging target 20 is a vehicle. The vehicle may have any body style of an automobile, such as a sports car, a coupe, a sedan, a pick-up truck, a station wagon, a sports utility vehicle, a minivan, a race car, or a conversion van. The vehicle may also embody other types of transportation, such as motorcycles, boats, buses, trains, and planes. The vehicle may be an electric vehicle, a fuel cell vehicle, a hybrid vehicle, or a conventional internal combustion engine vehicle. The vehicle may be operable by a driver occupying the vehicle, remotely controlled, and/or autonomous.

Charging target 20 may comprise a charger port 22, a target processor 24, a user interface 26, a power storage 28, and a memory 29, some of which may be optional. Charger port 22 may be configured to receive a charger to recharge power storage 28, e.g., a battery. For example, charging target 20 may be an electric vehicle that recharges its batteries through charger port 22. Target processor 24 may be a part of an onboard computer of charging target 20. Target processor 24 may be configured to control one or more components of charging target 20 to execute various methods and steps described in this disclosure, e.g., transmitting data with auto-charging assembly 10. User interface 26 may be configured to receive inputs from users or devices and transmit data. For example, user interface 26 may have a display including an LCD, an LED, a plasma display, or any other type of display, and provide a graphical user interface (GUI) presented on the display for user input and data display. User interface 26 may further include speakers or other voice playing devices. User interface 26 may further include input devices, such as a touchscreen, a keyboard, a mouse, a microphone, and/or a tracker ball, to receive a user input. User interface 26 may also connect to a network to remotely receive instructions or user inputs. Thus, the input may be directly entered by a user of charging target 20, captured by interface 26, or received by interface 26 over the network. In some embodiments, the user input may be a command to charge charging target 20. The user input may be received via user interface 26, third party device 30, mobile communication device 40, and/or auto-charging assembly 10. To execute the command, target processor 24 may transmit the command to auto-charging assembly 10. Responding to the command, auto-charging assembly 10 may perform the charging task, e.g., by performing method 200 described below with reference to FIG. 2.

User interface 26 may also be configured to receive user-defined settings. For example, user interface 26 may be configured to receive user profiles including, for example, an age, a gender, a driving license status, frequent destinations, vehicle charging frequencies, vehicle charging stations, and etc. In some embodiments, user interface 26 may include a touch-sensitive surface configured to receive biometric data (e.g., detect a fingerprint of a user). The touch-sensitive surface may be configured to detect the ridges and furrows of a fingerprint based on a change in capacitance and generate a signal based on the detected fingerprint, which may be processed by target processor 24. Target processor 24 may be configured to compare the signal with stored data to determine whether the fingerprint matches recognized users. Charging target 20 may also be able to connect to the Internet, obtain data from the Internet, and compare the signal with obtained data to identify the users. User interface 26 may be configured to include biometric data into a signal, such that target processor 24 can identify the person generating the input. User interface 26 may also compare a received voice input with stored voices to identify the person generating the input. Furthermore, user interface 26 may be configured to store data history accessed by the identified person. Based on the user identity and profiles, target processor 24 may order auto-charging assembly 10 to recharge charging target 20. The stored information or data may be located at memory 29, which may be non-transitory and computer-readable.

In some embodiments, user interface 26 may include one or more electrophysiological sensors for encephalography-based autonomous driving. For example, an electrophysiological sensor may detect electrical activities of brains of the user(s) and convert the electrical activities to signals, such that target processor 24 can execute a corresponding command, such as ordering auto-charging assembly 10 to recharge charging target 20.

Charging target 20 may be in communication with a plurality of devices, such as third party device 30 and mobile communication device 40. Mobile communication device 40 may include a smart phone, a tablet, a personal computer, a wearable device, such as a smart watch or Google Glass™, and/or complimentary components. Mobile communication device 40 may be configured to connect to a network, such as a nationwide cellular network, a local wireless network (e.g., Bluetooth™ or WiFi), and/or a wired network. Mobile communication device 40 may also be configured to access apps and websites of third parties, such as iTunes™, Google™, Facebook™, Yelp™, or other apps and websites associated with auto-charging assemble 10. Charging target 20, third party device 30, mobile communication device 40, and auto-charging assembly 10 may store and share data and information, such as a profile of charging target 20 (e.g., the year, make, model, and owner of a vehicle) and information of charger port 22 (e.g., the location of charger port 22 on the vehicle).

In some embodiments, mobile communication device 40 may be carried by or associated with one or more users of charging target 20. For example, auto-charging assemble 10 may be configured to determine the identity of a user based on a digital signature or other identification information from mobile communication device 40. For instance, target processor 24 may be configured to relate the digital signature to stored profile data including the person's name and the person's relationship with charging target 20. The digital signature of mobile communication device 40 may include a determinative emitted radio frequency (RF) or a global positioning system (GPS) tag. Mobile communication device 40 may be configured to automatically connect to or be detected by charging target 20 through local network 70.

Third party device 30 may include smart phones, personal computers, laptops, pads, servers, and/or processors of third parties. Third party devices 30 may be accessible to the users through mobile communication device 40 or directly accessible by target processor 24 and/or auto-charging assembly 10 via network 70. In some embodiments, auto-charging assembly 10 may obtain profiles of charging target 20, such as vehicle profiles, from charging target 20, third party device 30, and/or mobile communication device 40. The profile may include a location of charger port 22 on charging target 20, e.g., a position of a charger port of a vehicle in the 3D space relative to the vehicle.

Auto-charging assembly 10 may include a specialized onboard computer 110, a controller 120, an actuator system 130, and a sensor system 140. Onboard computer 110, actuator system 130, and sensor system 140 may all connect to controller 120. Onboard computer 110 may comprise, among other things, an I/O interface 112, a processing unit/processor 114, a storage unit 116, and a memory module 118, which may transfer data and send or receive instructions among one another. Storage unit 116 and memory module 118 may be non-transitory and computer-readable and may store instructions that, when executed by processing unit 114, cause one or more components of system 100 to perform the methods described in this disclosure. Onboard computer 110 may be specialized to perform the methods and steps described below. One or more of the components of auto-charging assembly 10 may be optional. For example, processing unit 114 may directly connect to sensor system 140, bypassing I/O interface 112 and controller 120. Therefore, it is not necessary that all of the above components be shown in order to disclose an illustrative embodiment.

I/O interface 112 may be configured for two-way communication between onboard computer 110 and various components of system 100. I/O interface 112 may send and receive operating signals to and from mobile communication device 40 and third party device 30. I/O interface 112 may send and receive the data between each of the devices via communication cables, wireless networks, or other communication mediums. For example, mobile communication device 40 and third party devices 30 may be configured to send and receive signals to I/O interface 112 via a network 70. Network 70 may be any type of wired or wireless network that may facilitate transmitting and receiving data. For example, network 70 may be a nationwide cellular network, a local wireless network (e.g., Bluetooth™ or WiFi), and/or a wired network.

Processing unit 114 may be configured to receive signals (e.g., sensor signals from sensor system 140, or a user input from charging target 20, third party device 30, or mobile communication device 40) and process the signals to determine a plurality of conditions of the operation of auto-charging assembly 10 (e.g., operations of various components of actuator system 130). Processing unit 114 may also be configured to generate and transmit command signals, via I/O interface 112, in order to actuate other assembly components.

Storage unit 116 and/or memory module 118 may be configured to store one or more computer programs that may be executed by onboard computer 110 to perform functions of auto-charging assembly 10. For example, storage unit 116 and/or memory module 118 may be configured to store profiles of various charging targets, charger port locations of the charging targets, and image recognition software configured to relate visual data to identities of charging targets. Storage unit 116 and/or memory module 118 may be further configured to store data and/or look-up tables used by processing unit 114.

Auto-charging assembly 10 can also include a controller 120 connected to onboard computer 110 and capable of controlling one or more aspects of operation of auto-charging assembly 10, such as approaching a charging target and/or other steps described below with reference to FIG. 2.

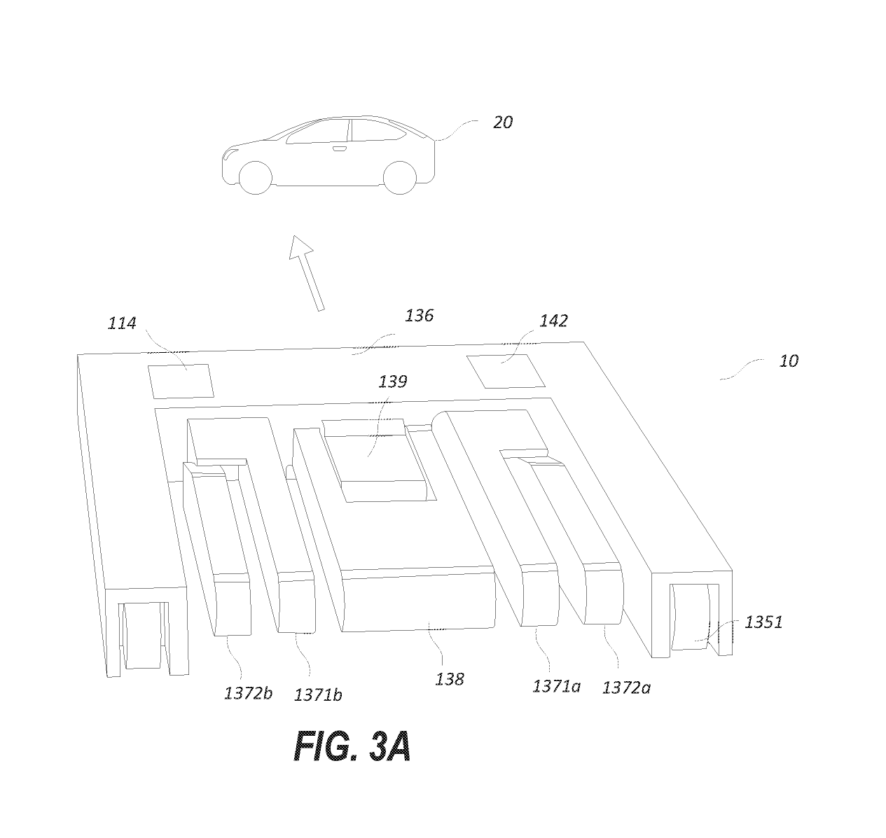

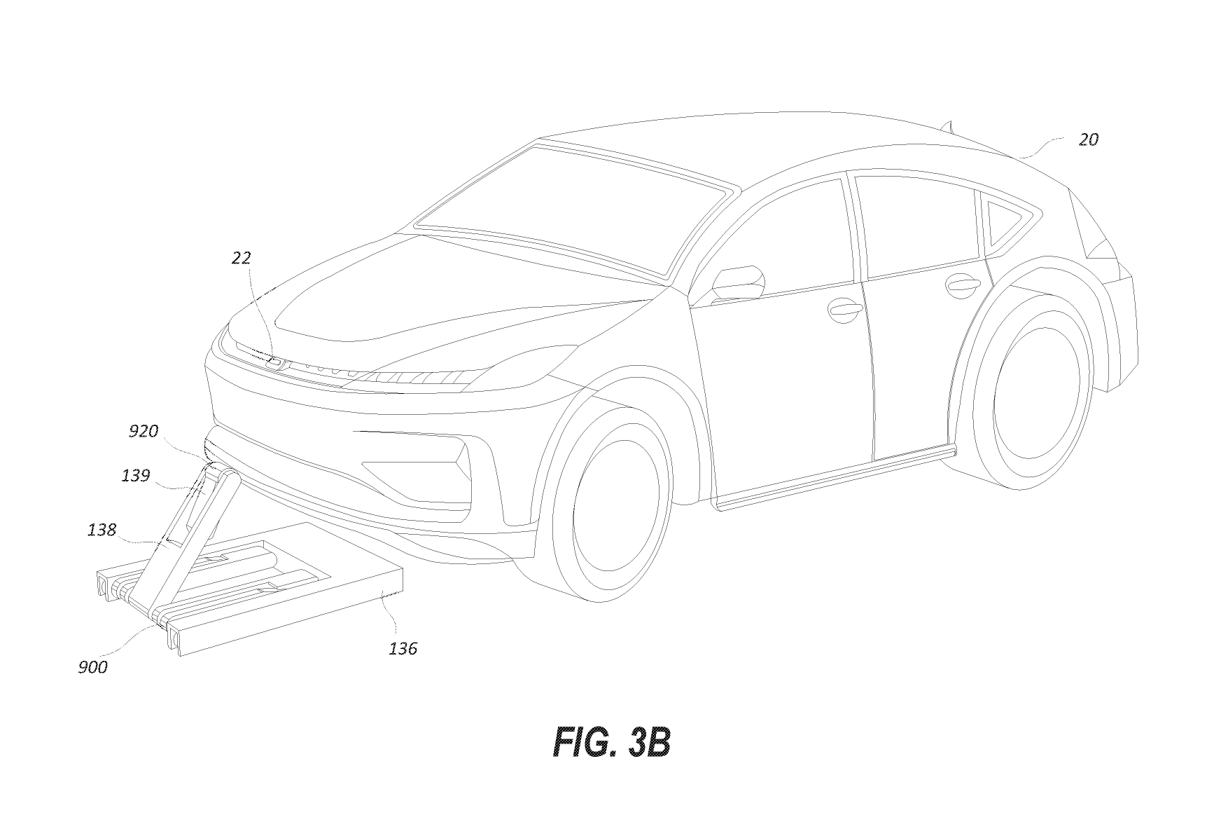

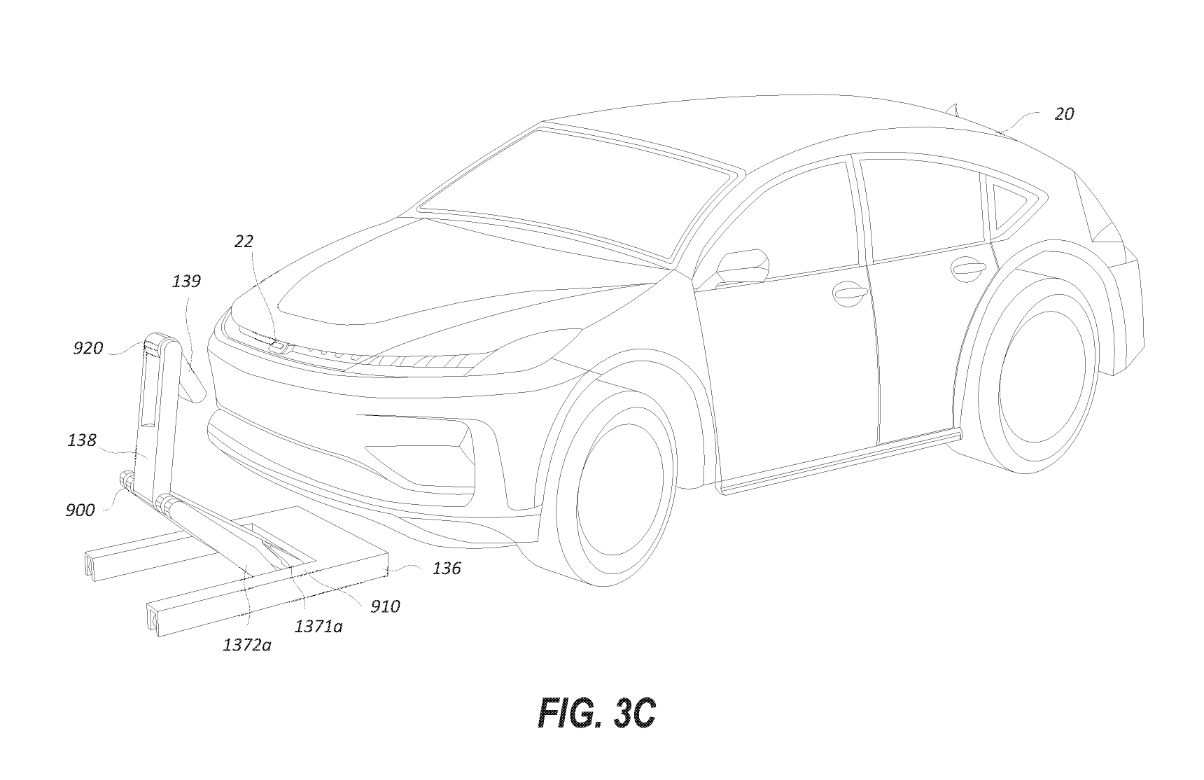

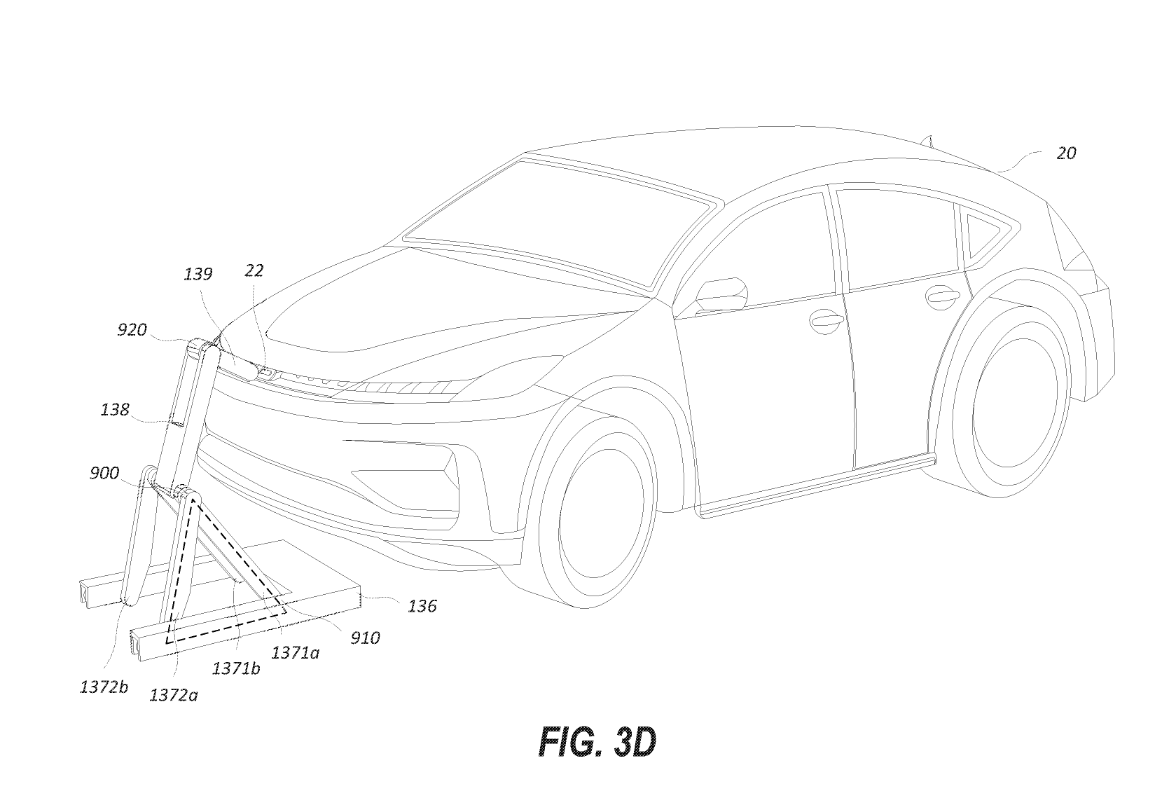

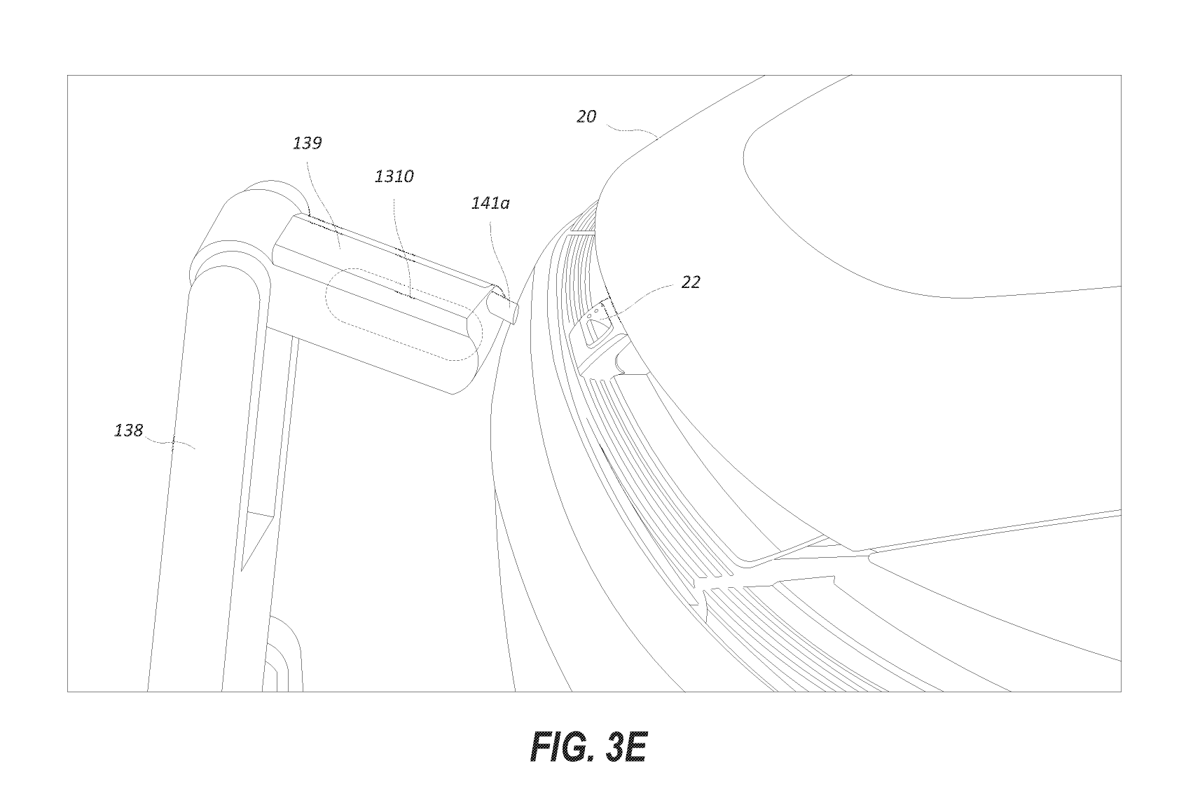

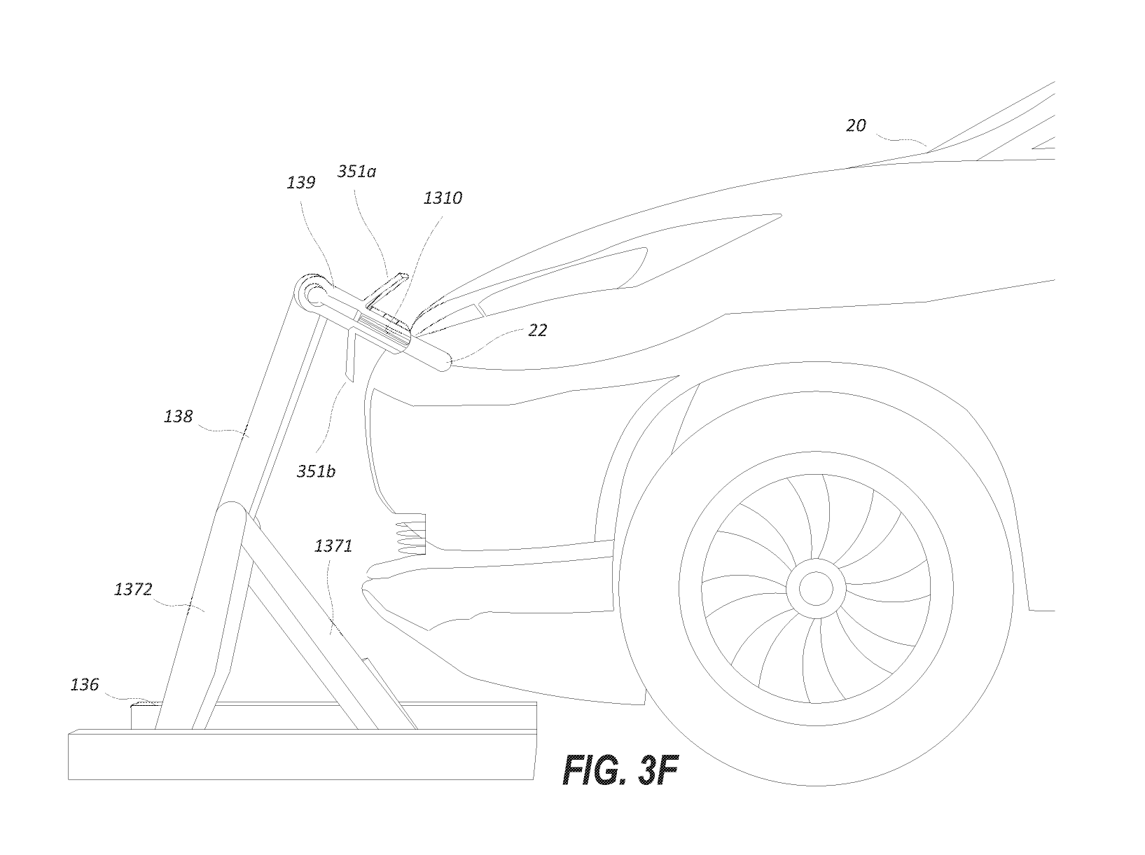

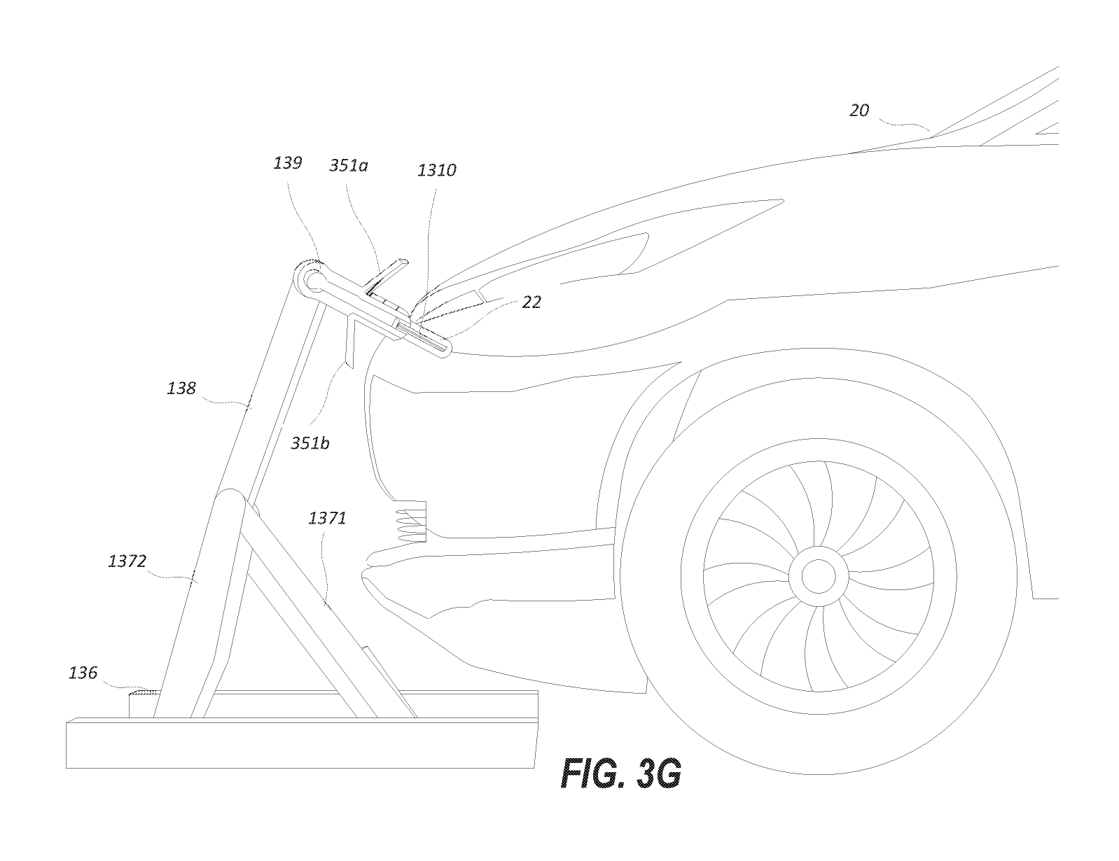

In some examples, controller 120 is connected to one or more actuator systems 130 and one or more sensor systems 140. One or more actuator systems 130 can include, but are not limited to, a motor 131, a power system 133, a brake 134, a motion system 135, a base 136, a set of lower arms 137, an upper arm 138, a charger arm 139, and a charger 1310. Motor 131 may comprise one or more motors disposed at various hinge joints of auto-charging apparatus 20 as described below with reference to FIGS. 3A-3G. Onboard computer 110 can control, via controller 120, one or more components of these actuator systems 130 during operation. For example, onboard computer 110 may control base 136 to move auto-charging assembly 10 in a certain direction at a certain speed, or control motor 131 to raise charger arm 139 to a certain height. Power system 133 may include one or more rechargeable batteries, e.g., lithium-ion batteries. Motion system 135 may comprise one or more wheels 1351, a track, levitation devices, or other mechanics configured to carry auto-charging assembly 10. In some embodiments, one or more wheels 1351 are attached to base 136. One or more wheels 1351 may be configured to roll in any direction on a surface, carrying base 136 and auto-charging assembly 10. To that end, one or more wheels 1351 may be comprise, for example, one or more mecanum wheels and/or one or more omni wheels. The set of lower arms 137 may include one or more first lower arms 1371 and one or more second lower arms 1372. Each lower arm may have a first end and a second end. The first end of first lower arm 1371 may be attached to base 136. The first end of second lower arm 1372 may be attached to base 136, free-hanging, supported by ground, or etc. The second end of first lower arm 1371 and the second end of second lower arm 1372 may be attached to a hinge joint. Upper arm 138 may have a first end attached to the hinge joint and have a second end. Charger arm 139 may have a first end attached to the second end of upper arm 138 and have a second end. Charger 1310 may be attached to the second end of charger arm 139. For example, charger 1310 may be hosted inside and extendible from the second end of charger arm 139. More details of structures and functions of the components of actuator system 130 are described below with reference to FIGS. 3A-3G.

Sensor system 140 may include one or more sensors, for example, a first sensor 141 and a second sensor 142. First sensor 141 and second sensor 142 may be disposed at, combined with, or integrated with various components of actuator system 130. As described below with reference to FIGS. 2 and 3A-3G, first sensor 141 and second sensor 142 may include a camera, a radio frequency transmitter/receiver, a Bluetooth transmitter/receiver, a WiFi transmitter/receiver, an ultrasound transmitter/receiver, an infrared transmitter/receiver, a prong sensor, a Hall effect sensor, and etc. A person with ordinary skill in the art should appreciate that sensor system 140 may include more than two sensors.

FIG. 2 is a flowchart illustrating an auto-charging method 200, consistent with exemplary embodiments of the present disclosure. Method 200 may include a number of steps and sub-steps, some of which may be optional. The steps or sub-steps may also be rearranged in another order. The steps of method 200 are described with reference to FIGS. 3A-3G, which are graphical illustrations corresponding to the various steps and are consistent with exemplary embodiments of the present disclosure.

In Step 210, one or more components of system 100, e.g., auto-charging assembly 10, may move to charging target 20. In some embodiments, charging target 20 may be a vehicle. In some embodiments, moving to charging target 20 comprises approaching charging target 20 and aligning with charger port 22 of charging target 20.

Step 210 may correspond to FIG. 3A. As illustrated in FIG. 3A and consistent with the above description of FIG. 1, auto-charging assembly 10 may be configured to approach charging target 20. One or more components of auto-charging assembly 10 may be in a folded state when auto-charging assembly 10 approaches charging target 20. For example, as shown in FIG. 3A, one or more first lower arms 1371a, 1371b, one or more second lower arms 1372a, 1372b, upper arm 138, and charger arm 139 are folded into base 136 when auto-charging assembly 10 moves toward charging target 20. Charger arm 139 may be folded into upper arm 138. That is, the above components of auto-charging assembly 10 may be folded to a level no taller than or at about at the same level as the top surface of base 136. The connections among the components are described below with reference to FIGS. 3B-3D. Moving auto-charging assembly 10 while keeping its components folded may reduce aerodynamic resistance, provide greater stability by maintaining a low center of gravity, and allow passage through narrow gaps and spaces. For example, the height of base 136 or the maximum height of a folded auto-charging assembly 10 may be designed to be lower than the bottoms of common cars, such that auto-charging assembly 10 can pass through the bottoms of the cars without obstruction and easily reaching charging targets in a narrow garage or a densely parked area. In some embodiments, base 136 may be configured to approach charging target 20. Base 136 may be configured to move on a surface based on various mechanisms, e.g., a wheel mechanism, a track mechanism, a magnetic levitation mechanism, and etc. In some embodiments, base 136 may comprise one or more wheels 1351, which may be mecanum wheels or omni wheels, configured to carry base 136 in any direction on the surface. As shown in FIG. 1, auto-charging assembly 10 may also comprise a processor 114 and a second sensor 142 disposed in base 136. Alternatively, processor 114, second sensor 142, and similar components can be disposed in upper arm 138 or other positions of auto-charging assembly 10.

There may be many methods for auto-charging assembly 10 to approach charging target 20, based on a relative position between auto-charging assembly 10 and charging target 20, a relative position of charger port 22 on charging target 20, and/or other similar principles. The relative position may be determined by auto-charging assembly 10 alone (referred to as an “active” detection), by auto-charging assembly 10 in conjunction of one or more external devices through network 70 (referred to as a “cooperative” detection), or by one or more external devices that transmit the relative position to auto-charging assembly 10 (referred to as a “passive” detection). In some embodiments, the location of auto-charging assembly 10 can be detected and/or monitored by itself, charging target 20, third party device 30, and/or mobile communication device 40 in real time.

With respect to the “active” detection, auto-charging assembly 10 may use a sensor to actively detect a charging target and/or determine a charging location, such as a charger port, of the charging target. In some embodiments, second sensor 142 may include a camera configured to capture visual data of a surrounding environment. Processor 114 may execute an image recognition program to compare the captured visual data with a stored profile of the charging target, a database of object images, or the like. Based on the comparison, processor 114 may detect an object, recognize an object, determine a charging target, determine a charging location on the charging target, and etc. For example, through captured visual data and/or stored profiles, processor 114 may determine a charger port location on the charging target in the 3D space. Based on the charger port location in the 3D space, processor 114 may determine a charging position on the ground surface and a charging direction, such that auto-charging assembly 10 can access the charger port when unfolded. Based on the visual data, processor 114 can determine the relative position between auto-charging assembly 10 and charging target 20. Then, processor 114 may control the base to move to the determined charging position and to position in the determined charging direction, achieving alignment of the assembly with charger port 22. For example, onboard computer 110 may store an image of the charging port of charging target 20. The image recognition program on onboard computer 110 may recognize the charging port on the image taken by second sensor 142, and determine that the charging port is on a left side of the image. Onboard computer 110 may instruct the base 136 to move to the left toward the charging port, and to align the base 136 with the charging port. Capturing and analyzing the images, and moving the base toward the charging port may be a continuous process until the base 130 is aligned with the charging port. In some embodiments, the initial alignment may be a coarse alignment to bring auto-charging assembly 10 into proximity of charging target 20. Fine alignment between charger arm 139 and charger port 22 may be performed next, as described below with reference to FIG. 3E.

With respect to the “cooperative” detection, auto-charging assembly 10 may communicate with an external device to detect a charging target and/or determine a charging location, such as a charger port, of the charging target. That is, auto-charging assembly 10 and an external device may cooperatively determine the charging position and/or the charging direction. For example, a user may use user interface 26 of charging target 20, third party device 30, and/or mobile communication device 40 to transmit a location of charging target 20 and/or a profile of charging target 20 to processor 114 of auto-charging assembly 10. Processor 114 may determine to approach charging target 20 based on the transmitted location. Processor 114 may also use second sensor 142 to visually monitor charging target 20, and may determine the changing position and the charging direction based on the monitored visual data and the transmitted profile. In some embodiments, sensor system 140 may include a GPS sensor or a location sensor to determine a location of auto-charging assembly 10. Processor 114 may receive the location information of auto-charging assembly 10, and instruct controller 120 and motion system 135 to move auto-charging assembly 10 to the location of charging target 20.

For another example, charging target 20 may include a wireless transmitter, an ultrasound transmitter, a radio frequency transmitter, a Bluetooth transmitter, and/or a WiFi transmitter, and auto-charging assembly 10 may include one or more corresponding sensors or receivers. Charging target 20 may transmit signals to auto-charging assembly 10 through the transmitter(s). Auto-charging assembly 10 may determine the location of charging target 20 or the location of the charging port based on the received signals. The above operations of the transmitters and sensors are not limited to the “cooperative” detection.

With respect to the “passive” detection, auto-charging assembly 10 may use a sensor to passively determine a charging target and/or determine a charging location, such as a charger port, of the charging target. That is, auto-charging assembly 10 may receive the charging position and/or the charging direction from an external device. For example, a user may use a joystick or a cellphone application to control auto-charging assembly 10 to move to the charging location and to position in the charging direction. For another example, auto-charging assembly 10 may receive an instruction to charge a charging target based on a given relative position between auto-charging assembly 10 and the charging target, and may proceed according to the instruction.

In Step 220, one or more components of system 100, e.g., auto-charging assembly 10, may unfold the set of lower arms 137, upper arm 138, and charger arm 139 from base 136.

Step 220 may comprise a number of sub-steps or states corresponding to FIGS. 3B-3D. As illustrated in FIGS. 3B-3D and consistent with the above description of FIG. 1, after auto-charging assembly 10 has approached charging target 20 (e.g., having moved to the charging location and positioned at the charging direction), auto-charging assembly 10 may unfold its various components to access charger port 22 of charging target 20. Similar to the description above, processor 114 and/or one or more external devices may control the motion or movement of the various components of auto-charging assembly 10 according to the “active,” “cooperative,” or “passive” manner.

As shown in FIG. 3B, auto-charging assembly 10 has moved to a charging location in front of a charging target 20 (e.g., a vehicle) close to charger port 22, and has positioned in the charging direction such that the various arms of auto-charging assembly 10 can access charger port 22. In some embodiments, the various arms of auto-charging assembly 10 may be designed to move in six degrees of freedom and the charging direction may not need to be determined in method 200. That is, in these embodiments, as long as auto-charging assembly 10 has moved to an area close enough to the charger port, such that the charger port can be reached by arms from auto-charging assembly 10, method 200 can proceed without determining the charging direction, since the arms, after being unfolded, may adjust accordingly to locate and access the charger port. In FIG. 3B, auto-charging assembly 10 has positioned in a direction roughly aligned with charger port 22. Upper arm 138 may now unfold, e.g., raise up, from base 136. The movement of upper arm 138 may be caused by a motor disposed in hinge joint 900 and coupled to upper arm 138. Hinge joint 900 is described in more details below with reference to FIG. 3D. Optionally, charger arm 139 may start unfolding from upper arm 138. Similarly, the movement of charger arm 139 may be caused by a motor disposed in hinge joint 920 and coupled to charger arm 139. Hinge joint 920 is described in more details below with reference to FIG. 3D.

As shown in FIG. 3C, first lower arm 1371 (e.g., 1371a and 1371b) may unfold, e.g., raise up, from base 136. At the same time, second lower arm 1372 (e.g., 1372a and 1372b) may unfold, e.g., raise up, from base 136. For example, second lower arm 1372 may be controlled to raise up from base 136. For another example, second lower arm 1372 may be dragged up by first lower arm 1371 via a connection with first lower arm 1371. Optionally, upper arm 138 may continue its previous movement, and charger arm 139 may continue unfolding from upper arm 138. Similarly, the movement of first lower arm 1371 may be caused by a motor disposed in hinge joint 910 and coupled to first lower arm 1371. Hinge joint 910 is described in more details below with reference to FIG. 3D. The movement of second lower arm 1372 may be caused by a motor disposed in hinge joint 900 and coupled to second lower arm 1372. Hinge joint 900 is described in more details below with reference to FIG. 3D.

As shown in FIG. 3D, the various arms of auto-charging assembly 10 are unfolded from base 136. Base 136 is positioned on a surface. First lower arm 1371 (e.g., 1371a and 1371b) has a first end attached to base 136 (e.g., through hinge joint 910) and have a second end. Hinge joint 910 may include a motor coupled to first lower arm 1371. The motor may be configured to rotate first lower arm 1371 relative to base 136, and thus to raise first lower arm 1371. Second lower arm 1372 (e.g., 1372a and 1372b) also has a first end and a second end. The second end of first lower arm 1371 and the second end of second lower arm 1372 may be connected through a hinge joint 900. The first end of second lower arm 1372 may be attached to base 136, may be slidable along a side surface of base 136, or may be supported by the ground surface. First lower arm 1371 may comprise a pair of first lower arms 1371a and 1371b, and the second lower arm 1372 may comprise a pair of second lower arms 1372a and 1372b, such that all of their second ends are connected through hinge joint 900. Upper arm 138 may have a first end also attached to hinge joint 900. Hinge joint 900 may include a motor coupled to upper arm 138 and/or second lower arm 1372. The motor may be configured to rotate upper arm 138 relative to the lower arms 1371 and 1372, and thus to raise upper arm 138. The motor may also be configured to rotate move second lower arm 1372 away from first lower arms 1371 to form a triangle described below. Upper arm 138 may also have a second end. Charger arm 139 may have a first end attached to the second end of upper arm 138 (e.g., through hinge joint 920). Hinge joint 920 may include a motor coupled to charger arm 139. The motor may be configured to rotate charger arm 139 relative to upper arm 138, and thus to align with charger port 22. Charger arm 139 may have a second end configured to align with charger port 22.

As shown in FIG. 3D, when the set of lower arms of auto-charging assembly 10 are unfolded, first lower arm 1371, second lower arm 1372, and base 136 may form a triangle to support upper arm 138. For example, first lower arm 1371a, second lower arm 1372a, and a corresponding long side of U-shaped base 136 may form one triangle, as indicated in dash lines; and first lower arm 1371b, second lower arm 1372b, and the other long side of U-shaped base 136 may form another triangle. For the U shape design of base 136, the inner space between the two long sides can be used to host the various arms when folded. The inner corners of U-shaped base 136 can steadily lock the first end(s) of first lower arm 1371 in position(s) when unfolded. The first end(s) of second lower arm 1372 can also be locked, e.g., by a latching or sliding mechanism with the inner surface of base 136, or by friction against the surface. Thus, the triangular structure can be locked in position to allow fine alignment with charger port 22. Moreover, the large covering area of base 136 and/or the triangle structure can provide stable support for upper arm 138 and charger arm 139 in an unfolded state, by keeping the center of gravity of auto-charging assembly 10 low. The structural stability can further allow auto-charging assembly 10 to reduce its weight and lower the manufacturing cost. For example, the various arms and base 136 may be hollow to host wires or other components. For another example, portions of upper arm 138 near its second end may be hollowed out to host charger arm 139 in a folded state.

The above description and illustration of various components of auto-charging assembly 10 may be modified or altered in various manners to achieve similar results.

In Step 230, one or more components of system 100, e.g., auto-charging assembly 10, may deliver charger 1310 to charger port 22 of charging target 20.

Step 230 may comprise a number of sub-steps or states corresponding to FIGS. 3E-3G. As illustrated in FIGS. 3E-3G and consistent with the above description of FIG. 1, after auto-charging assembly 10 has unfolded its various components, it may deliver charger 1310 to charger port 22 of charging target 20. Similar to the description above, processor 114 and/or one or more external devices may control the motion or movement of the various components according to the “active,” “cooperative,” or “passive” manner.

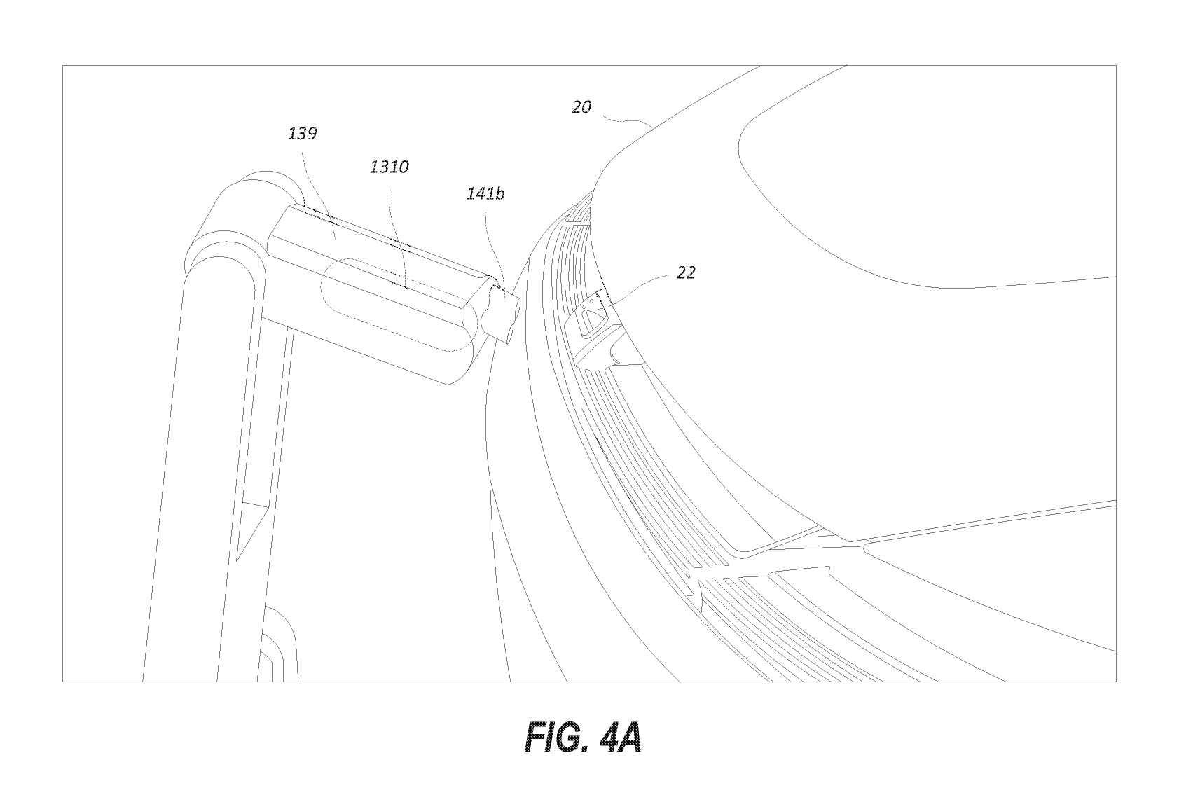

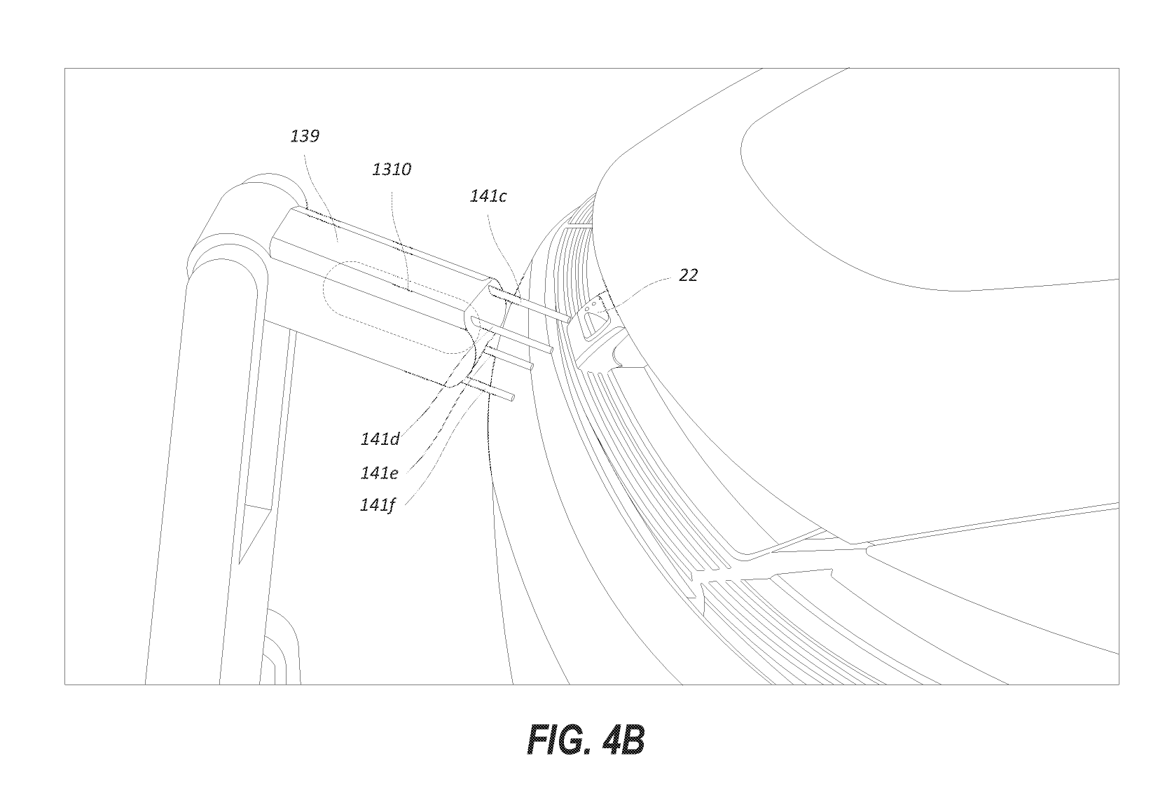

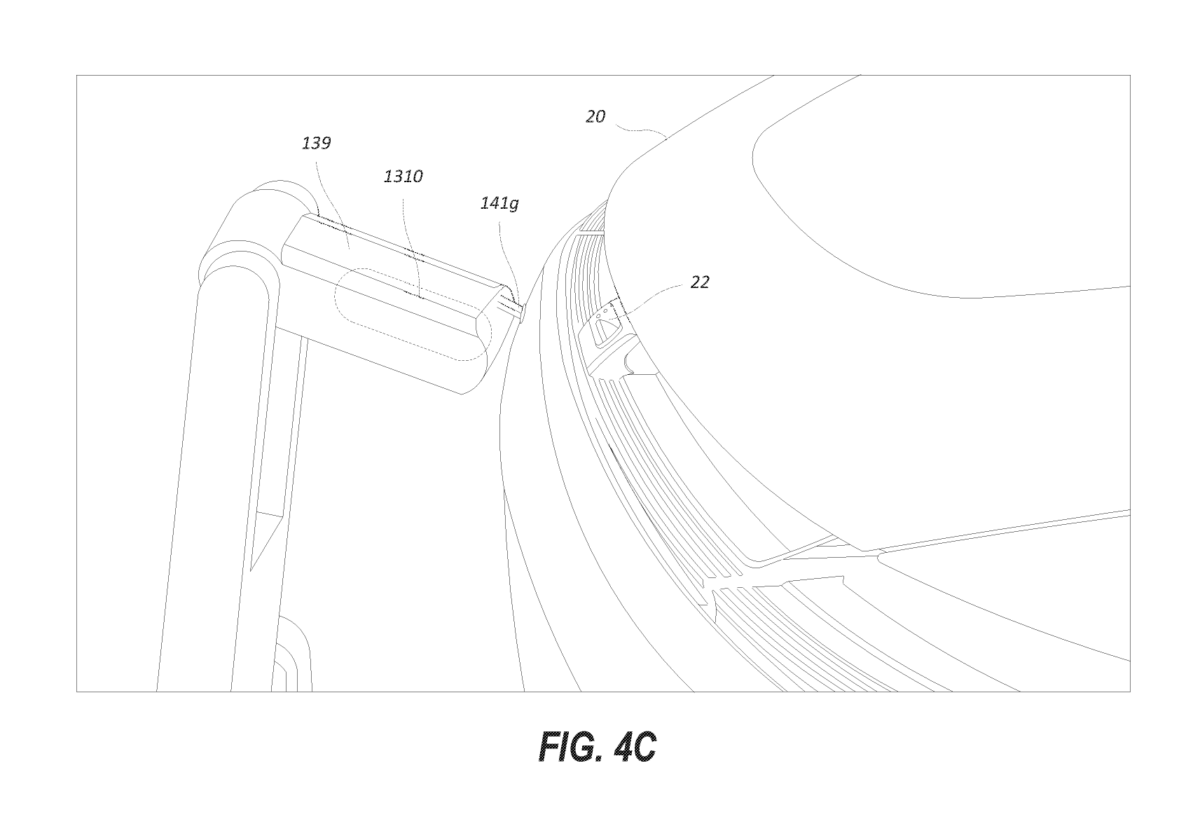

As illustrated in FIG. 3E, charger arm 139 may use first sensor 141 to align its second end with charger port 22. Inside the second end, charger arm 139 may comprise a charger 1310 (not shown in FIG. 3E, but shown in FIG. 3F and FIG. 3G). Charger arm 139 or another component of auto-charging assembly 10 may include one or more sensor configured to align the charger arm, e.g., the second end of charger arm 139, with charger port 22. For example, charger arm 139 may comprise, at its second end, a camera 141a as first sensor 141, the camera being configured to capture visual data; and processor 114 may be configured to compare the captured visual data with a profile of charger port 22 to align the charger 1310 with charger port 22. Camera 141a may be disposed above charger arm 139, partially or entirely inside charger arm 139, or at another position on auto-charging assembly 10, as long as it can capture charger port 22. Charger 1310 is drawn in dash line since it is hosted inside charger arm 139 at this step. Processor 114 may execute an image recognition program to recognize charger port 22 and align charger 1310 with charger port 22. For another example, referring to FIG. 4A, charger arm 139 may comprise, at its second end, an ultrasonic sensor 141b as first sensor 141, the ultrasonic sensor being configured to receive ultrasonic signals from charger port 22; and processor 114 may be configured to analyze the ultrasonic signals received by the ultrasonic sensor to align charger 1310 with charger port 22. Ultrasonic sensor 141b may be disposed above charger arm 139, partially or entirely inside charger arm 139, or at another position on auto-charging assembly 10, as long as it can reach charger port 22. For yet another example, referring to FIG. 4B, charger arm 139 may comprise, at its second end, one or more prong sensors 141c-141f as first sensor 141, the prong sensors being configured to touch a surface and determine a topology of the surface by detecting how much each sensor retracts from an equilibrium position of not touching any object. Prong sensors 141c-141f may be disposed at another position on auto-charging assembly 10, as long as they can reach charger port 22. Processor 114 may be configured to analyze the determined topology to align charger 1310 with charger port 22, for example, by matching a stored topology of charger port 22 with a sensed topology. The accuracy of the detected topology may increase with the number of prong sensors. For example, three or four prong sensors may form a basic setup and every additional prong sensor may increase the accuracy by a certain percentage. For yet another example, referring to FIG. 4C, charger arm 139 may comprise, at its second end, one or more Hall effect sensors 141g as first sensor 141. In some embodiments, certain magnetic field(s) may be caused by emitters positioned around the entrance of charger port 22, e.g. four corners of the charge port 22. The Hall effect sensors may detect the magnetic field and send signals to cause the second end of charger arm 139 to move towards an increasing Hall field. Accordingly, charger arm 139 can align with charger port 22. The Hall effect sensors may be disposed at another position on auto-charging assembly 10, as long as they can detect charger port 22. The above sensor or embodiments can be combined to achieve the alignment with charger port 22. For example, the Hall effect sensors can be incorporated at the tips of the prong sensors.

As illustrated in FIG. 3F, when the alignment is determined, auto-charging assembly 10 may engage the second end of charger arm 139 with charger port 22. In this figure, charger arm 139 may have opened cover 351a and 351b to allow delivery of charger 1310.

As illustrated in FIG. 3G, charger arm 139 may deliver charger 1310 into charger port 22. Charger port 22 may be connected to power storage 28, e.g., a battery, of charging target 20. For example, charger 1310 may be inserted into charger port 22 until a latch inside sensor port 22 is hit or until a sensor inside sensor port 22 sends a secure signal. Hitting the latch or receiving the secure signal may indicate that charger 1310 has been safely inserted into and has engaged with charger port 22.

After the successful insertion and engagement, charger 1310 may be energized to charge power storage 28 through charger port 22. Charger 1310 may be powered by various methods. For example, charger 1310 may connect to a battery stored in base 136 through an internal wire. For another example, charger 1310 may connect to an external power source through a cable. A first end of the cable may connect to charger 1310. The cable may pass through the first end of charger arm 139 and the second end of upper arm 138, and exit auto-charging assemble 10 through the first end of upper arm 138 to connect to the external power source. For another example, charger 1310 may connect to an external power source through a cable that is connected to a series of bus bars, where the bus bars are enclosed within the charge arms. In one such embodiment, a series of bus bars are enclosed within charger arm 139, the second end of upper arm 138, second lower control arm 1372, and one side of base 136. The bus bars are electrically connected to each other by way of either a flex cable or an electrically conductive joint. The bus bars are connected to an external power source through a cable that connects to the bus bar in base 136. For yet another example, charger 1310 may connect to a transmitter coil disposed inside base 136 through an internal wire, and the transmitter coil may inductively couple to a receiver coil embedded in the surface on which the assembly stands, such that the charger is wirelessly powered by the external power source.

While the charging is in progress, the charger may determine information such as charging time, a remaining charging time, and a battery level, and transmit such information to target processor 24, third party device 30, mobile communication device 40, and/or processor 114. Thus, a user of charging target 20 may keep track of the charging progress through various means.

Once the charging is completed, auto-charging assembly 10 may automatically de-energize charger 1310, disengage charger port 22, and fold back the various arm by retracting the steps described above. Then, auto-charging assembly 10 may move away from charging target 20, e.g., to a home position.

Another aspect of the disclosure is directed to a non-transitory computer-readable medium storing instructions which, when executed, cause one or more processors to perform the method, as discussed above. The computer-readable medium may include volatile or non-volatile, magnetic, semiconductor, tape, optical, removable, non-removable, or other types of computer-readable storage medium or computer-readable storage devices. For example, the computer-readable medium may be the storage unit or the memory module having the computer instructions stored thereon, as disclosed. In some embodiments, the computer-readable medium may be a disc or a flash drive having the computer instructions stored thereon.

A person skilled in the art can further understand that, various exemplary logic blocks, modules, circuits, and algorithm steps described with reference to the disclosure herein may be implemented as specialized electronic hardware, computer software, or a combination of electronic hardware and computer software. For examples, the modules/units may be implemented by one or more processors to cause the one or more processors to become one or more special purpose processors to executing software instructions stored in the computer-readable storage medium to perform the specialized functions of the modules/units.

The flowcharts and block diagrams in the accompanying drawings show system architectures, functions, and operations of possible implementations of the system and method according to multiple embodiments of the present invention. In this regard, each block in the flowchart or block diagram may represent one module, one program segment, or a part of code, where the module, the program segment, or the part of code includes one or more executable instructions used for implementing specified logic functions. It should also be noted that, in some alternative implementations, functions marked in the blocks may also occur in a sequence different from the sequence marked in the drawing. For example, two consecutive blocks actually can be executed in parallel substantially, and sometimes, they can also be executed in reverse order, which depends on the functions involved. Each block in the block diagram and/or flowchart, and a combination of blocks in the block diagram and/or flowchart, may be implemented by a dedicated hardware-based system for executing corresponding functions or operations, or may be implemented by a combination of dedicated hardware and computer instructions.

As will be understood by those skilled in the art, embodiments of the present disclosure may be embodied as a method, a system or a computer program product. Accordingly, embodiments of the present disclosure may take the form of an entirely hardware embodiment, an entirely software embodiment or an embodiment combining software and hardware for allowing specialized components to perform the functions described above. Furthermore, embodiments of the present disclosure may take the form of a computer program product embodied in one or more tangible and/or non-transitory computer-readable storage media containing computer-readable program codes. Common forms of non-transitory computer readable storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same.

Embodiments of the present disclosure are described with reference to flow diagrams and/or block diagrams of methods, devices (systems), and computer program products according to embodiments of the present disclosure. It will be understood that each flow and/or block of the flow diagrams and/or block diagrams, and combinations of flows and/or blocks in the flow diagrams and/or block diagrams, can be implemented by computer program instructions. These computer program instructions may be provided to a processor of a computer, an embedded processor, or other programmable data processing devices to produce a special purpose machine, such that the instructions, which are executed via the processor of the computer or other programmable data processing devices, create a means for implementing the functions specified in one or more flows in the flow diagrams and/or one or more blocks in the block diagrams.

These computer program instructions may also be stored in a computer-readable memory that can direct a computer or other programmable data processing devices to function in a particular manner, such that the instructions stored in the computer-readable memory produce a manufactured product including an instruction means that implements the functions specified in one or more flows in the flow diagrams and/or one or more blocks in the block diagrams.

These computer program instructions may also be loaded onto a computer or other programmable data processing devices to cause a series of operational steps to be performed on the computer or other programmable devices to produce processing implemented by the computer, such that the instructions (which are executed on the computer or other programmable devices) provide steps for implementing the functions specified in one or more flows in the flow diagrams and/or one or more blocks in the block diagrams. In a typical configuration, a computer device includes one or more Central Processing Units (CPUs), an input/output interface, a network interface, and a memory. The memory may include forms of a volatile memory, a random access memory (RAM), and/or non-volatile memory and the like, such as a read-only memory (ROM) or a flash RAM in a computer-readable storage medium. The memory is an example of the computer-readable storage medium.

The computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The computer-readable medium includes non-volatile and volatile media, and removable and non-removable media, wherein information storage can be implemented with any method or technology. Information may be modules of computer-readable instructions, data structures and programs, or other data. Examples of a non-transitory computer-readable medium include but are not limited to a phase-change random access memory (PRAM), a static random access memory (SRAM), a dynamic random access memory (DRAM), other types of random access memories (RAMs), a read-only memory (ROM), an electrically erasable programmable read-only memory (EEPROM), a flash memory or other memory technologies, a compact disc read-only memory (CD-ROM), a digital versatile disc (DVD) or other optical storage, a cassette tape, tape or disk storage or other magnetic storage devices, a cache, a register, or any other non-transmission media that may be used to store information capable of being accessed by a computer device. The computer-readable storage medium is non-transitory, and does not include transitory media, such as modulated data signals and carrier waves.

The specification has described auto-charging methods, apparatus, and systems. The illustrated steps are set out to explain the exemplary embodiments shown, and it should be anticipated that ongoing technological development will change the manner in which particular functions are performed. Thus, these examples are presented herein for purposes of illustration, and not limitation. For example, steps or processes disclosed herein are not limited to being performed in the order described, but may be performed in any order, and some steps may be omitted, consistent with the disclosed embodiments. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

While examples and features of disclosed principles are described herein, modifications, adaptations, and other implementations are possible without departing from the spirit and scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

It will be appreciated that the present invention is not limited to the exact construction that has been described above and illustrated in the accompanying drawings, and that various modifications and changes can be made without departing from the scope thereof. It is intended that the scope of the invention should only be limited by the appended claims.

What is claimed is:

1. An auto-charging system, comprising:
a base;
a set of lower arms, comprising a first lower arm and a second lower arm each having a first end and a second end, wherein:
the first end of the first lower arm is attached to the base, and
the second ends of the first and second lower arms are connected to a hinge joint;
an upper arm having a first end attached to the hinge joint and a second end;
a charger arm having a first end attached to the second end of the upper arm and a second end, wherein the set of lower arms, the upper arm, and the charger arm are foldable into the base; and
a charger attached to the second end of the charger arm, wherein:
the base is configured to approach a charging target;
the set of lower arms, the upper arm, and the charger arm are configured to unfold from the base; and
the charger arm is configured to deliver the charger to a charger port of the charging target.

2. The system of claim 1, wherein when the set of lower arms are unfolded, the first lower arm, the second lower arm, and the base are configured to form a triangle to support the upper arm.

3. The system of claim 1, wherein the charger arm comprises a first sensor configured to locate the charger port.

4. The system of claim 1, wherein:
the first sensor comprises a camera; and
the system further comprises a processor configured to compare visual data captured by the camera with a stored profile of the charger port to align the charger with the charger port.

5. The system of claim 1, wherein:
the first sensor comprises an ultrasound sensor configured to receive ultrasound signals from the charger port; and
the system further comprises a processor configured to analyze the ultrasound signals received by the ultrasound sensor to align the charger with the charger port.

6. The system of claim 1, wherein:
the first sensor comprises one or more prong sensors configured to touch a surface and determine a topology of the surface; and
the system further comprises a processor configured to analyze the determined topology to align the charger with the charger port.

7. The system of claim 1, further comprising a second sensor on the base, the second sensor configured to capture visual data of the charging target.

8. The system of claim 7, further comprising a processor configured to compare the captured visual data with a stored profile of the charging target to determine a charging location on the charging target.

9. The system of claim 8, wherein the processor is configured to move the base to the charging location.

10. The system of claim 1, wherein the base comprises at least one wheel selected from a group consisting of one or more mecanum wheels and one or more omni wheels.

11. The system of claim 1, wherein the charging target is a vehicle.

12. An auto-charging method, comprising:
moving an auto-charging apparatus to a charging target, wherein the auto-charging apparatus comprises:
a set of lower arms, comprising a first lower arm and a second lower arm each having a first end and a second end, wherein:
the first end of the first lower arm is attached to the base, and
the second ends of the first and second lower arms are attached to a hinge joint;
an upper arm having a first end attached to the hinge joint and a second end;
a charger arm having a first end attached to the second end of the upper arm and a second end; and
a charger attached to the second end of the charger arm;
unfolding the set of lower arms, the upper arm, and the charger arm from the base; and
delivering the charger to a charger port of the charging target.

13. The method of claim 12, wherein unfolding the set of lower arms, the upper arm, and the charger arm from the base comprises forming a triangle with the first lower arm, the second lower arm, and the base to support the upper arm.

14. The method of claim 12, wherein:
the charger arm comprises a camera; and
to deliver the charger to the charger port of the charging target, the method further comprises comparing visual data captured by the camera with a stored profile of the charger port to align the charger with the charger port.

15. The method of claim 12, wherein:
the charger arm comprises an ultrasound sensor configured to receive ultrasound signals from the charger port; and
to deliver the charger to the charger port of the charging target, the method further comprises analyzing the ultrasound signals received by the ultrasound sensor to align the charger with the charger port.

16. The method of claim 12, wherein:
the apparatus further comprises a second sensor on the base; and
to deliver the charger to the charger port of the charging target, the method further comprises:
capturing visual data of the charging target by the second sensor; and
comparing the captured visual data with a stored profile of the charging target to determine a charging location on the charging target.

17. The method of claim 12, wherein:
the charger arm comprises one or more prong sensors configured to touch a surface and determine a topology of the surface; and
to deliver the charger to the charger port of the charging target, the method further comprises analyzing the determined topology to align the charger with the charger port.

18. The system of claim 11, wherein the base comprises at least one wheel selected from a group consisting of one or more mecanum wheels and one or more omni wheels.

19. The method of claim 11, wherein the charging target is a vehicle.

20. An automatic vehicle-charging system, comprising:
a base;
a set of lower arms, comprising a first lower arm and a second lower arm each having a first end and a second end, wherein:
the first end of the first lower arm is attached to the base, and
the second ends of the first and second lower arms are attached to a hinge joint;
an upper arm having a first end attached to the hinge joint and a second end;
a charger arm having a first end attached to the second end of the upper arm and a second end, wherein the set of lower arms, the upper arm, and the charger arm are foldable into the base; and
a charger attached to the second end of the charger arm, wherein:
the base is configured to approach a vehicle;
the set of lower arms, the upper arm, and the charger arm are configured to unfold from the base; and
when the set of lower arms are unfolded, the first lower arm, the second lower arm, and the base are configured to form a triangle to support the upper arm; and
the charger arm is configured to deliver the charger to a charger port of the vehicle.
